(19) United States
(12) Patent Application Publication
(10) Pub. No.: US 2009/0218266 A1
(43) Pub. Date: Sep. 3, 2009

(54) WATER TREATMENT AND METHODS OF USE

(76) Inventors: Reyad Sawafta, Greensboro, NC (US); Yousef Haik, Greensboro, NC (US)

Correspondence Address: REYAD SAWFTA;QUARTEK CORP., 4180 PIEDMONT PARKWAY, GREENSBORO, NC, 27410, US

(21) Appl. No.: 12/041,145

(22) Filed: Mar. 3, 2008

(51) Int. Cl. C02F 1/68

(52) U.S. Cl. 210/198.1

(57) ABSTRACT

The present invention describes a novel antimicrobial ion delivery system (IDS) article, methods of making the article, and its applications in water disinfection. The novel IDS entails a source of oligodynamic metal ions embedded in a matrix that allows for the release of metal ions in water at biocidals concentrations. The preferred IDS contains particles made of metallic alloys and bound to a matrix that ensures the controlled release of ions in water. The novel IDS is safe for use in animals and humans and it is environment friendly and biodegradable.

### CROSS-REFERENCE TO RELATED APPLICATIONS

This application claims the benefit of U.S. Provisional Applications Nos. 60/888343 and 60/821497 and U.S. Patent Application No. 200711868475 filled on Oct. 06, 2007 and 2007858157 filled on Sep. 20, 2007 that are incorporated by reference into the content application in their entireties.

### SUMMARY OF THE INVENTION

We claim a novel delivery system (DS) for metallic ions with biocidal properties and its use in water disinfection. The metal ion yielding material may be a metallic salt or mixture of metallic salts, but in a preferred embodiment of the invention the metal ion yielding material will consist of particles made of metallic alloys and bound to an environment-friendly matrix. Classes of metal alloy compositions which are used as particles and display superior antimicrobial properties are described in US Pat. Appl. 200711868475 and in US Pat. Appl. 200711858157. Particles consisting of metal alloys of two or more elements and mixture of these classes of particles can be embedded in the matrix to yield mix population of metal ions as required by the application. Preferred matrices that contain the particles are polymeric structures. The term “polymeric” is understood to mean that the composition comprises one or more monomers, oligomers, polymers, copolymers, or blends thereof. Other potential matrices to bind the metallic particles are cellulose materials (e.g. paper, cardboard) and textiles (e.g. woven and non-woven). Controlled release of the ions is performed by encapsulation in a environmentally friendly porous barrier (e.g carbon coat, ceramic coat and or natural coat).

We claim that the described IDS may be manufactured as a disposable or rechargeable article. We claim multiple applications for the IDS described herein such as disinfection of water used in residential and office settings, industrial or dental/medical or military settings, outdoor (e.g. recreational water) and indoor, food packaging, cosmetics, and finally for human or animal use.

### FIELD OF THE INVENTION

The invention relates to biocidal compositions comprising a source of oligodynamic metal ions and a matrix that contains this source of metal ions. The invention presents methods of preparing this novel ion delivery system (IDS) and also its applications in water disinfection.

### BACKGROUND OF THE INVENTION

Exposing the public to microbe contaminated water represents a serious health problem. During 1999-2000, a total of 39 outbreaks associated with drinking water were reported by 25 states and a total of 59 outbreaks associated with recreational water were reported by 23 states. Two outbreaks not associated with drinking or recreational water exposure were reported during this period. During 2003-2004, a total of 36 water borne disease and outbreaks (WBDOs) were reported by 19 states; 30 were associated with drinking water, three were associated with water not intended for drinking, and three were associated with water of unknown intent. The 30 drinking water-associated WBDOs caused illness among an estimated 2,760 persons and were linked to four deaths (http://www.cdc.gov/mmwr/preview/mmwr). Water disinfection encompasses a continuum of outcomes in terms of the types of microorganisms destroyed. Microorganisms can be grouped as following in terms of decreasing resistance to disinfectants: bacterial endospores (B. subtilis, Clostridium spp); Mycobacteria; nonlipid or small viruses (poliovirus, rhinovirus); fungi; vegetative bacteria; and, lipid or medium sized virus (Herpes simplex, HIV, HBV). Biocidal agents commonly used in water disinfection are halogens, ozone, UV, quaternary amine compounds, hydrogen peroxide, sodium monopersulphate, and metals ions. The use of metals for water disinfection is known from antiquity and their recent revival is explained by the resistance that microorganisms acquired to the usual treatments. For example, the biofilm formation in dental water units is resistant to antimicrobial treatment and its removal usually requires the use of a combination of harsh biocidal agents. Also some of the still potent agents such as chlorine alter the properties of water to a level that is unacceptable for the end user. For example, although chlorine is the most potent disinfectant, chlorinated drinking water is not palatable for the consumer and neither is the chlorinated pool water for the swimmers.

The biostatic/biocidal properties of metals ions such as silver, copper, and zinc are well-known. Modern technologies that employ metals for their antimicrobial effects show encouraging results in a variety of bacteria (E. coli, S. aureus, S. epidermidis, S. pneumoniae, P. aeruginosa), viruses (Herpes simplex, HIV, Nile virus), and fungi (A. niger, C. albicans). So far, metals ions have been used for this purpose under various forms, such as metal colloids (salts, oxides) or alloys. Water treatment using biocidal metals ions is performed using metal salts, in which case the rapid consumption of the ions curtails the longevity of the disinfectant effect. Metal ions are readily complexed with organic matter in the contaminated water and they become unavailable to attack microorganisms. Therefore a continuous production of ions is needed to achieve biocidal levels beyond the complexation with organic matter in the treated water. The only proven method that provides a continuous discharge of ions in water is ionization. This method has been used since the 1980's for recreational water disinfection, but it is however expensive and requires complex equipment which makes the process cumbersome for the consumer. The antimicrobial properties of metallic nanoparticles have not been extensively reported, and even less their use for water disinfection purposes. Recent work conducted with silver showed that both metallic nanoparticles and ionic salt were activated in the presence of moisture, but metallic silver was active much longer than the ionic silver on microorganisms. Silver nanoparticles have also been tested for their antimicrobial properties when impregnated into a polymer, in coating, or in wound dressing as described in U.S. Pat. No. 6,866,859 and its incorporated references. Studies have also examined the oligodynamic properties of other metals, including gold, cobalt, nickel, titanium, iron, and vanadium as described in U.S. Pat. No. 7,001,452. Data on the antimicrobial properties of these alloys in a nanoparticulate form is not available. Limited data which are available with regard of these metals or metal alloys suggest that these agents may have biocidal activity against a wide array of bacteria, fungi, and protozoa. Among all known metals silver seems to be the favorite antimicrobial metal and its use alone or in combination with copper and zinc has been reported for water treatment. The precise antimicrobial effects depend on the metal of interest, environmental conditions, and the targeted pathogens.

Although the broad assumption of increased toxicity for nanoscale materials is not unanimously supported by evidence, existing and emerging regulatory specifications have been increasingly addressing the importance of size when it comes to nanomaterials. Therefore it is desirable to design a water treatment composition that does not release metallic particles while it allows the release of metallic ions in the water. Depending on the application, these particles can be immobilized in a matrix with a complete preservation of their biocidal properties. This approach will limit the environmental burden and comply with the regulatory specifications regarding the use of nanomaterials. Various matrices have been tested as a support for the herein disclosed biocidal particles, such as polymeric, cellulose, ceramic, carbon, or textile materials.

### DESCRIPTION OF THE INVENTION

The present invention describes a novel IDS that comprises a source of metal ions with biocidal properties and a matrix that immobilizes the source of ions and provides a sustained release of ions at biocidal concentration. The main purpose of such biocidal IDS is water disinfection, although other applications such as food packaging, preservation, personal care, construction, agriculture, biodefense and others are not excluded.

As used herein the terms “particles” refer to metallic particles but also to salts and any particulate materials than can be a source of metal ions.

As used herein, the terms “comprise,” “comprising,” “include,” and “including” are intended to be open, non-limiting terms, unless the contrary is expressly indicated.

As used herein, the term “composition” is intended to be used for alloys that have two or more elements or combinations of alloys that are produced by a preferred technique as described herein and has preferred biocidal properties and they have a size above 5 nm.

As used herein, the terms “biocidal”, “nanocidal”, “biocidal nanoparticles” are intended to be used as antimicrobial, antibacterial, antifungal, anti algae, antiviral, and other pathogenic organisms. The broad biocidal spectrum includes Gram+ and Gram− bacteria, spore and non-spore forming bacteria, viruses, vegetative and non-vegetative fungi, yeast, protozoa, and other microorganisms.

As used herein, the terms “nanocomposites”, “nanoparticles”, “particles” and “nanomaterials” are intended to be used for structure of any shape and composition with dimensions between 0-2000 nm.

The source of metal ions. Metal ions with antimicrobial properties, such as silver, copper, zinc, and others are obtained by dissolving the corresponding metal salts in water or by the release of ions from their metallic sources. Preferred metal salts used to readily yield metal ions are halides, nitrates, sulfates, carbonates, silicates, oxides, and hydroxydes. These salts can be used as alone or in combination when they are incorporated in the matrix of choice. When longevity of the biocidal effect provided by the IDS described herein is desired, the preferred source of metal ions is represented by metallic particles. Various classes of metallic particles with strong biocidal properties against bacteria, fungi, and viruses have been described in our US Pat Appl 20070087659. Different classes of particles have been produced by varying the elemental composition of the alloys, the elemental ratios within the same alloy, or by changing parameters in the synthesis process. As needed, these particles may be synthesized in various size ranges from 5 nm to 2000 nm, and preferred under 1000 nm, and most preferred between 100 nm and 300 nm. In one embodiment particles made of two or more element alloys have superior biocidal properties compared to one element particles. In one embodiment a combination of transition metals 3d of the periodical table such as Chromium or Manganese or Iron or Cobalt or Nickel or Copper or Zinc or 4d Silver or 5d Gold, or rare earth metals from the lanthanides such as Cerium, or Neodymium, or Samarium, or Gadolinium, or Terbium, or Dysprosium, or Holmium, or Erbium, or alkali metals such as Lithium, or Sodium, or Potassium, or Magnesium, or Calcium in a binary or tri or quad combination with different percentages will compose a preferred biocidal nanoparticles class. In one preferred embodiment, a composition is synthesized where Silver is a dominant element in the composition of the form AgₐM_{b}N_{c}Q_{d}, where a, b, c, and d are the proportion of the elements in the composition of the nanoparticles. (M), (N) and (Q) are other elements used in the composition. In a preferred sub-embodiment, (M) can be one of the following metals, Chromium or Manganese or Iron or Cobalt or Nickel or Copper or Zinc or Gold, or a rare earth material such as Cerium, or Neodymium, or Samarium, or Gadolinium, or Terbium, or Dysprosium, or Holmium, or Erbium, or Lithium. (N) can be any one of the elements described above under (M) but also Silver. (Q) can be any one of the elements described above under (M) but also Silver. In this composition, a is ranging from 50-99.7%, b ranging from 0.1-49.8%, c ranging from 0.1-49.8% and d ranging from 0.1-49.8%.

In another preferred sub-embodiment the composition have three elements in the composition where Silver remains the dominant element in the composition in the form AgₐM_{b}N_{c}. In a preferred sub-embodiment, (M) can be one of the following metals, Chromium or Manganese or Iron or Cobalt or Nickel or Copper or Zinc or Gold, or a rare earth material such as Cerium, or Neodymium, or Samarium, or Gadolinium, or Terbium, or Dysprosium, or Holmium, or Erbium, or Lithium. (N) can be any one of the elements described above under (M) but also Silver. In this composition, a is varying from 50%-99.8% and b is varying from 0.1%-49.9% and c is varying from 0.1-49.9%.

In another preferred sub-embodiment where the composition have two elements where Silver is a dominant element in the form AgₐM_{b} where (M) can be one of the following elements, Chromium or Manganese or Iron or Cobalt or Nickel or Zinc or Gold, or a rare earth material such as Cerium, or Neodymium, or Samarium, or Gadolinium, or Terbium, or Dysprosium, or Holmium, or Erbium, or Lithium. In this composition, a is varying from 50-99.9% and b is varying from 0.1-50%.

In another preferred embodiment of the present invention, is that the composition possesses magnetic properties to enable detection and collection of particulates at the site of use. Detection of magnetic particles is described in prior arts. The collection of the magnetic particulate can be done utilizing permanent magnet or electromagnet fixtures.

In another preferred embodiment of the present invention is that the composition has a preferred color generated by either the particulate or the matrix.

In another preferred embodiment of the present invention is that the composition is made with the least effective volume of particulate and matrix. In a sub-embodiment, the composition is made in the most cost effective manner.

In another preferred embodiment of the present invention is the preparation method of nanoparticles. The nanoparticles can be prepared in conventional chemical or physical method. The nanoparticles can further be prepared in c chemical green method. Further control of the particle size can be obtained by additional treatment of the particle with solutions that have pH range from 1 to 14.

The matrix. The source of metal ions is immobilized in a matrix and the efficient release of ions depends on parameters such as metal salt concentration and solubility, particle size, concentration, and density in the matrix, and their interaction with water. The latter property is dictated by the hydrophilic nature of the matrix as well as its 3-D structure.

In one embodiment, the composition of the IDS includes a polymeric material. The term “polymeric” is understood to mean that the composition comprises one or more monomers, oligomers, polymers, copolymers, or blends thereof. Examples of polymers include polyvinyl alcohol, poly ethylene glycol, ethyl cellulose, polyolefins, polyesters, nonpeptide polyamines, polyamides, polycarbonates, polyalkenes, polyvinyl ethers, polyglycolides, cellulose ethers, polyvinyl halides, polyhydroxyalkanoates, polyanhydrides, polystyrenes, polyacrylates, polymethacrylates, polyurethanes, polypropylene, polybutylene terephthalate, polyethylene terephthalate, nylon 6, nylon 6,6, nylon 4,6, nylon 12, phenolic resins, urea resins, epoxy resins, silicone polymers, polycarbonates, polyethylene vinylacetate, polyethylene ethyl acrylate, polylactic acid, polysaccharides, polytetrafluoroethylene, polysulfones and copolymers and blends thereof.

In one preferred embodiment, the composition is attached to the surface of the polymeric material by a retention agent. The retention agents utilizes both surface charge interaction and/or viscous retention by act of gluing between the composition and the polymeric material.

In one embodiment the polymeric material is biocompatible, and preferably biodegradable. Examples of suitable polymers include ethylcelluloses, polystyrenes, poly(ε-caprolactone), poly(d,l-lactic acid), polysaccharides, and poly(d,l-lactic acid-co-glycolic acid). The polymer is preferably a copolymer of lactic acid and glycolic acid (e.g., PLGA, PVA or Chitosan).

In another preferred embodiment, the composition is encapsulated by a coating material to control the level of ion release. Such coating materials include ceramics, carbon, natural compounds with porous pores.

Other suitable matrices for particles are cellulose materials such as paper and cardboard or fabrics (woven or non-woven) to which particles are optionally bound using specific binders as described below.

Methods of making the IDS. This invention discloses methods of making the antimicrobial IDS article. The size and shape of the final delivery system may vary as required by the application. For example, polymeric matrices containing particles may be presented as foams (open or closed-cell foam), films, or discs. Particles are added into the matrix at a concentration determined by the targeted load in the final product. It is disclosed in this application that the uniform dispersion of particles in the matrix is achieved using dispersant agents such as surfactants and most preferably ionic liquids (ILs). The most preferred ILs are those derived from imidazolium salts, and among which the most preferred is 1-propyl-3-methylimidazolium (PMI). In the presence of PMI an aqueous suspension of metallic particles remains in a stable colloidal state, disperses uniformly in the matrix, and improves the particle loading capacity of the matrix.

In one embodiment of the invention particles are uniformly mixed with the matrix (e.g. polymeric mix, paper slurry) in solutions with pH that varies from 1 to 14, and then the mixture processed (e.g. casting, extrusion, co-extrusion, heat pressing) at determined temperatures. Alternatively, the matrix can acquire the particle load by spraying, coating, in situ particle synthesis, or submersion in a suspension of particles followed by drying. In those cases where the IDS consists of a combination of matrices, the addition of particles may be part of a multi-step process. For example, a polymeric foam containing particles may constitute an IDS on its own, or it may contain an additional matrix containing particles. This latter matrix (e.g dried pulp, polymeric film, fabric) may be added to the polymeric foam in various ways. First, a grafting method could be used where the polymeric mix of the foam is cast in situ onto a coupon/layer/sheet of the secondary matrix prepared a priori. The new IDS may have the secondary matrix partially or totally enclosed in the polymeric foam. Second, a coupon/layer/sheet of the secondary matrix that contains particles could be inserted in a preformed polymeric foam that presents pockets or slots to accommodate additional matrices.

The approaches in which the IDS may be made are briefly presented below. Variations of the procedures briefly described below should be evident to those skilled in the art.

Polymeric coupons. Particles are mixed in the polymeric melt (e.g. EVA, PVA, polysterene) and then molded under the desired shape or size. Alternatively, Particles can be deposited on the surface of a polymeric surface by means of spraying, coating, imprinting, or in situ deposition.

Polyurethane foam-based IDS. One preferred foam matrix is polyurethane-based which is obtained through a process that comprises a mixture of polymers (e.g. PVA, Chitosan), isocyanates (e.g. toluene diisocyanate, methylene diphenyl diisocyanate), polyols (e.g. polyethers and polyesters), and organometallic catalysts (e.g. dibutyltin dilaurate and stannous octoate). The most preferred polyurethane composition uses the natural polyol castor oil and a decreased amount of isocyanate to obtain foam that is more environmental friendly.

Polymeric films-based IDS. Depending on the application, films composition may include one or more polymers (e.g. PVA, chitosan, HPMC), crosslinkers (e.g. gluteraldehyde, UV and heat curing), plasticizers (e.g. glycolates, citrates, ionic liquids), and colorants. Particles are blended in the film composition and the films prepared by casting or extrusion at room temperature or under heat conditions.

Paper or cardboard-based IDS. First, particles are mixed with the optional substances known in the papermaking industry such as sizing agents, retention aid polymers, binders, fillers, etc. Examples of sizing agents are from the groups of rosin, alkyl ketene dimmers, or alkenyl succinic anhydride (ASA). Retention aids can be from the groups of coagulation, flocculation, and entrapment agents. Examples of binders include but are not limited to PVA, carboxymethylcellulose, starch and modified starch, polyacrylamide and modified polyacrylamide, acrylate and methacrylate, polyols and modified polyols, glycoxal and glycoxal urea, diisocyanate and diisocynate compounds, and resins. Then the particles-chemicals mix is added to the watery pulp that may or may not have undergone bleaching. After stirring, the mix is then poured into the mold, drained, and then sent to the paper machine.

Fabric (woven and non-woven)-based IDS. Particles can be added to the fiber before or after extrusion or to the fabric itself during the finishing stages. A binder material that adheres the particles to the target yam and/or fabric surface provides highly beneficial durability for the yams. Preferably, this component is a polyurethane-based binding agent, although other types, such as a permanent press type resin or an acrylic type resin. The selected substrate may be any fabric comprising individual fibers or yarns of any typical source for utilization within fabrics, including natural fibers (cotton, wool, ramie, hemp, linen, and the like), synthetic fibers (polyolefins, polyesters, polyamides, polyaramids, acetates, rayon, acylics, and the like), and inorganic fibers (fiberglass, boron fibers, and the like) or combination of thereof. The target fabrics may be of any standard construction, including knit, woven, or non-woven forms. The uniform distribution of beads in the yarn/fabric is achieved by submersing the material in an aqueous solution of particles. Subsequently, particle-impregnated material is removed from the solution and dried.

Coating with Allantoin. Allantoin is added to a mixture of salt solutions of bicoidal composition salts compromising of sources for Ag, Cu, Zn Mg and Li. Chitosan solution was added to the mix. The mixture was heated. Allantoin was added to the mix to form metal alloy-allantoinate complex. The dried product was ground in a grinder to provide a fine, white powder (96.2% yield).

Coating with Calcium Sulfate. CaSO₄ was added to a mixture of salt solutions of biocidal ion releasing composition. Chitosan solution was added to the mix and heated for 5 minutes. Additional CaSO₄ was added to to the above mixture. The dried product was ground in a grinder to provide a fine, white powder (98.2% yield). The powered showed excellent biocidal action. A mixture of allantoin CaSO₄ was also produced. Other coating materials such as TiO2 and Carbon has been also produced and tested. The combination showed superior biocidal action with controlled release of the biocidal ions.

Mixture of coatings compromising of on or combination of polymeric (HPMC, HPC, PVA, Polystyrene, etc.), CaSO4, TiO2, Carbon have been produced and tested to show superior biocidal action.

Methods of Using the Ion Delivery System (IDS). This invention discloses potential applications of the antimicrobial IDS article in water disinfection. Depending on the application, IDS may be disposable or reusable. Disposable IDS will have a determined amount of particles bound to the matrix and it will be discarded once the ion discharge and therefore the antimicrobial effect are consumed. In the case of reusable DS, the final article is designed to accommodate inserts (e.g. slots or pockets) containing particles bound to various matrices. In this case not only that the final IDS article is reusable, but it can also be loaded with various doses of biocidal agent as required by the contamination conditions (e.g. treatment of heavy microbial load vs. maintenance or preventive treatment). Also the latter scenario can facilitate a multi-treatment session where in each slot/pocket various biocidal agents are loaded (e.g. metal ion yielding insert and sodium chlorite load for disinfection of recreational waters, or metal ion yielding insert and citric acid load for cleaning of dental water unit).

This invention also describes controlled release IDS system compromising of coated biocidal composition in powered form or in coated layered articles that can be placed in water purification system. The mixture of coated polymeric materials or powdered system is stacked in a water purification column. Coating with carbon (adsorbent material) enables, in addition to the antimicrobial functionality, the article to also purify water systems from solid particulate waste.

Generally, the method includes placing the biocidal IDS article having a selected composition at a site intended for water disinfection and preservation (e.g. recreational water, dental water units) or treatment and prevention (e.g. antiseptic for wounds, lesions, oral care).

1. A novel delivery system for water disinfection that comprises two elements:
a. a source of biocidal agent(s)
b. carrier for the biocidal agent.

2. Said source of biocidal agent(s) in claim 1 may be but is not limited to the following materials used on their own or in combination:
a. metal salts (e.g. sulfate, carbonate, chloride) or
b. metal particles (e.g. bi-, tri-, or quaternary element alloy composition of elements).
c. particulate metallic alloys (e.g. bi-, tri-, or quaternary element alloy composition of elements), which is the most preferred source of metal ions.

3. Said source of biocidal agent(s) in claim 1 may consist of one class or mixture of classes of metal salts, metal particles, or most preferred of particulate metallic alloys.

4. Said metal and metal alloy particles in claim 2 may have a size varying from 5 nm to 2000 nm, and preferred under 1000 nm, and most preferred between 100 nm and 300 nm.

5. Said metal and metal alloy particles in claim 2 are maintained in a stable colloidal suspension using dispersant agents such as but not limited to surfactants and most preferably ionic liquids (ILs) or acids such as but not limited to lactic acid, glycolic acid and acetic acid.

6. Said metal particles in claim 2 are in the form of binary, trinary and quaternary element alloy compositions with variations based on weight of each of the elements with a percentage by weight that covers a range of 5% up to 95% for each of the elements in the composition or in the range up to 1% up to 99% for each of the elements in the composition.

7. Said metal particles in claim 2 have a quaternary element alloy compositions in the form LₐM_{b}N_{c}Q_{d}, where (L) is a metal that has a dominant percentage in the formulation. (L) is one of the following metals, Chromium or Manganese or Iron or Cobalt or Nickel or Copper or Zinc, or Silver or Gold, or a rare earth material such as Cerium, or Neodymium, or Samarium, or Gadolinium, or Terbium, or Dysprosium, or Holmium, or Erbium, or Lithium or Sodium, or Potassium, or Magnesium, or Calcium. (M) is one of the elements described above under (L) but except the dominant element for the specific combination. (N) is one of the elements described above under (L) including the element that is dominant for the specific combination but except the element in (M). (Q) is one of the elements described above under (L) including the element that is dominant for the specific combination but except the element in (N). The proportion of elements in each composition is indicated by a, b, c, and d where a can vary from 26%-99.7%, b can vary from 0.1-49.8%, c can vary from 0.1-49.8% and d can vary from 0.1-49.8%.

8. Said preferred quaternary element compositions described in claim 7 are AgCuCoLi, AgCuZnLi, AgCoZnLi, AgCuCoZn, AgCuLiMg and combinations thereof.

9. Said metal particles in claim 2 have a trinary element alloy composition in the form of LₐM_{b}N_{c} where (L) is the dominant element in the composition. (L) is one of the following metals, Chromium or Manganese or Iron or Cobalt or Nickel or Copper or Zinc, or Silver or Gold, or a rare earth material such as Cerium, or Neodymium, or Samarium, or Gadolinium, or Terbium, or Dysprosium, or Holmium, or Erbium, or Lithium. (M) is one of the elements described above under (L) but except the dominant element for the specific combination. (N) is one of the elements described above under (L) including the element that is dominant for the specific combination but except the element in (M). The proportion of elements in each composition is indicated by a, b, and c where a can vary from 3450%-99.8%, b can vary from 0.1-49.9%, c can vary from 0.1-49.9%.

10. Said preferred tri element compositions described in claim 9 are AgCuCo, AgCuNi, AgCuLi, AgZnCu, CuAgLi, CuCoAg, CuCoZn, CuCoLi, CuZnAg, , ZnAgCu, ZnCuLi, ZnAgLi, ZnCoLi, AgCuMg and combinations thereof.

11. Said metal particles in claim 2 have a binary element alloy composition in the form of LₐM_{b} where (L) is the dominant element in the alloy composition. (L) is one of the following metals, Chromium or Manganese or Iron or Cobalt or Nickel or Copper or Zinc, or Silver or Gold, or a rare earth material such as Cerium, or Neodymium, or Samarium, or Gadolinium, or Terbium, or Dysprosium, or Holmium, or Erbium, or Lithium. (M) is one of the elements described above under (L) but except the dominant element for the specific combination. The proportion of elements in each composition is indicated by a and b, where a can vary from 50%-99.9%, b can vary from 0.1-50.

12. Said preferred binary element compositions described in claim 11 are AgCu, CuAg, ZnCu, CuZn, AgZn, ZnAg, NiCu, CuNi, AgLi, LiAg, CuLi, LiCu, AgMg, and combinations thereof.

13. Combinations of compositions mentioned in claims 7, 9, and 11 are preferred.

14. Said metal salts in claim 2 may be present in the IDS as salts alone or in combination of two, three, or multiple salts.

15. Said metal salts in claim 2 may have in their composition metals with biocidal properties such as but not limited to Ag, Cu, Co, Zn, Ni, Li, Mg, Ca, Hg, and Cd.

16. Said metal salts in claim 2 may be from the class of but not limited to halides, nitrates, sulfates, carbonates, silicates, oxides, and hydroxydes.

16. Said metal particles in claim 2 may have in their composition one of the metals with biocidal properties such as but not limited to Ag, Cu, Co, Zn, Ni, Li, Mg, Ca, Hg, and Cd.

17. Biocidal agent is released from the source in said claim 2 is a metal ion or a mixture of metal ions with oligodynamic properties such as, but not limited to Ag, Cu, Co, Zn, Ni, Mg, Ca and Li.

18. The carrier for the biocidal agent in claim 1 is a material that allows the interaction between the metal ion source and water and the controlled release of the biocidal agent in water.

19. Said carrier in claim 1 can be in forms such as but not limited to open-cell and closed-cell polymeric foams, soft polymeric films, flexible and rigid discs, cardboard, paper, napkins, wipes, tissues and fiberglass, and woven and non-woven fabric materials.

20. Said biocidal agent in claim 1 are coated with allantoin, calcium sulfate, calcium phosphate, titanium dioxide, carbon, polymer (e.g. natural or synthetic) or combination thereof.

21. Said carrier in claim 1 contains the metal ion source as an integral part blended in its composition or as a renewable insert.

22. Said carrier in claim 1 that contains the metal ion source blended in its composition is discarded after the consumption of the biocidal properties.

23. Said carrier in claim 1 that contains the metal ion source as an insert is reusable upon the replacement of the insert loaded with metal ion source.

24. Said IDS for water disinfection in claim 1 can be used alone or in combination with other biocidal/biostatic agents.

25. Said IDS for water disinfection in claim 1 can be used alone or in combination with other biocidal/biostatic agents in residential and office settings, industrial or dental/medical or military settings, outdoor (e.g. recreational water) and indoor, food packaging, cosmetics, and finally for human or animal use.

26. Said IDS for water disinfection in claim 1 is nontoxic and eco-friendly.

27. Said IDS for water disinfection in claim 1 possess magnetic properties

28. Said IDS for water disinfection in claim 1 possess distinct color

29. Siad IDS for water disinfection in claim 1 have color concealling properties based on the compoistion of the coat in claim 20 and can be used in UV-resistant coating in applications where discoloration due to metals is to be avoided.

30. Said IDS for water disinfection in claim 1 possesses potent activity for a wide range of pH preferably from pH3-6 and preferably from pH 7-10 and most preferably from pH6-7.

31. Said IDS for water disinfectant in claim 1 show controlled and sustained ion release in aqueous environment based on the unique alloy composition and synthesis conditions and based on the hydrophilic and hydrophobic properties of the coating materials such as but not limited to ceramics, carbon.
